(19) United States
(12) Patent Application Publication
(10) Pub. No.: US 2023/0379298 A1
(43) Pub. Date: Nov. 23, 2023

(54) NETWORK BLOCK ADDRESS REGISTRATION AND CLAIMING

(71) Applicant: Roger B. Marks, Denver, CO (US)

(72) Inventor: Roger B. Marks, Denver, CO (US)

(21) Appl. No.: 18/248,383

(22) PCT Filed: Oct. 11, 2021
(86) PCT No.: PCT/US2021/054450

§ 371 Date: Apr. 9, 2023

(51) Int. Cl. H04L 61/5092

(52) U.S. Cl. CPC H04L 61/5092; H04L 2101/622

(57) ABSTRACT

A computer network includes a claimant configured to send a first discover message to a first identifying address. The first identifying address identifies a first plurality of claimed addresses for potential use by the claimant as network source or destination addresses. Methods and computer program products for claiming network addresses are also described.

### TECHNICAL FIELD

The present invention relates to data networks, and more specifically, to the assignment of unicast and multicast addresses for use in such a network.

### BACKGROUND ART

In computer data networks, a unicast address may uniquely identify an entity that serves as a source and a singular destination. A multicast address may identify a group of destinations.

In some cases, it is useful for a unicast address to be not preassigned but instead dynamically assigned to a device for use in the network. Likewise, it is sometimes useful for a multicast address to be dynamically assigned to a device for its use, such as for transmitting a data stream from that device to a multicast recipient group. In some cases, dynamically assigned addresses are self-assigned by a claimant that claims them. In these cases, it is typical for a claimant to announce, to other devices that may also have self-assigned addresses or may need to self-assign addresses in the future, a self-assignment claim; in this way, the claimants exchange information about their claims or intended claims. When a device learns, from such announcements, that an address to which it has a claim or which it intends to claim is also the subject of the claim of another device, it may take action to remediate the conflict, since duplicate address assignments are problematic and must be avoided. Such action may, for example, involve releasing its claim or its tentative claim, or notifying the remote device of the conflict and encouraging the remote device to release its claim.

An example of such an address claiming protocol is, for example, the MAC Address Acquisition Protocol of IEEE Std 1722-2016. Another example is specified in the VN2VN (Virtual N_Port to Virtual N_Port) protocol within Fibre Channel over Ethernet (FCoE) specifications.

Claim announcements are intended to be exchanged among devices that self-assign from a pool of addresses in which a conflict may arise. In the prior art, the announcements are typically sent, repeatedly and frequently, to a multicast destination address to which all devices sharing the address pool listen. When a message is received at such an address, the recipient processes the message and determines the nature of the announcement. If it is an announcement regarding address claims, the device extracts from the announcement the details regarding the address claim and compares the address claim to its own claim. If a conflict is found, the device takes action to remediate the conflict.

This approach is illustrated in FIG. 1, which shows a number of devices, each serving as a claiming device (101) of an address set (104). In FIG. 1, there are six claiming devices (101) labeled (101a)-(101f), claiming address sets (104a)-(104f), respectively. Each claiming device (101) is connected to a common forwarding network (102) and enabled to send a commonly-addressed claim 103) (identified as (103a)-(103f), respectively) to the forwarding network (102) and likewise receive a similar commonly-addressed claim 103) from the forwarding network (102). The forwarding network (102) is enabled to forward a commonly-addressed claims 103) to claiming devices (101) following transmission to the forwarding network (102) from another claiming device (101).

In FIG. 1, a claiming device (101) claims an address set. For example, claiming device (101a) chooses to claim an address set Sₐ and sends a commonly-addressed claim 103a) to the forwarding network (102). The commonly-addressed claim 103a) is a claim 103) M_{CA} that indicates the set Sₐ and is addressed to a multicast destination address with the value D. As indicated in FIG. 1, this commonly-addressed claim 103a) is abbreviated as M_{CA}(Sₐ)[D], wherein the first parameter (in the parentheses) indicates the claim content and the second parameter (in the square brackets) indicates the claim destination. Likewise, claiming device (101b) chooses to claim an address set S_{b} and sends a commonly-addressed claim 103b), specifically M_{CA}(S_{b})[D], to the forwarding network (102), etc. Each commonly-addressed claim 103) indicates a common multicast address D, and each indicates the specific address set of the claim.

### SUMMARY OF INVENTION

According to a first aspect of the present invention, a claimant is provided in a computer network. The claimant is configured to send a first discover message to a first identifying address. The first identifying address identifies a first plurality of addresses for potential use by the claimant as network source or destination addresses.

According to one embodiment, the first identifying address can be a multicast address.

According to one embodiment, the claimant can be further configured to enable sending a data message whose source or destination address is within the first plurality of addresses identified in the first discover message.

According to one embodiment, the claimant can be further configured to: in response to receiving a claimed message indicating that the first plurality of addresses, identified by the first identifying address, is unavailable, send a second discover message to a second identifying address, the second identifying address being a multicast address identifying a second plurality of addresses for potential use by the claimant as network source or destination addresses

According to a second aspect of the present invention, a claimant is configured to receive a message containing an address block identifier as an indication of a plurality of addresses identified by the address block identifier, wherein the address block identifier's length is no larger than the length of any address within the plurality of addresses, and to enable sending of a data message whose source or destination address is within the plurality of addresses.

According to one embodiment, the plurality of addresses includes both unicast and multicast addresses.

According to a third aspect of the present invention, a method of claiming network addresses for use in a computer network is provided. The method includes sending, by a claimant, a first discover message to a first identifying address, the first identifying address identifying a first plurality of addresses for potential use by the claimant as network source or destination addresses in a computer network.

According to a fourth aspect of the present invention, a computer program product is provided for claiming network addresses for use in a computer network. The computer program product comprises a non-transitory computer-readable storage medium storing instructions that when executed by a computer configure the computer to perform a method of claiming network addresses. The method includes sending, by a claimant in a computer network, a first discover message to a first identifying address. The first identifying address identifies a first plurality of addresses for potential use by the claimant as network source or destination addresses in a computer network.

The details of various aspects and embodiments of the invention are set forth in the accompanying drawings and the description below, which includes a description of the novel Block Address Registration and Claiming (BARC) method and system.

Other features and advantages of the invention will be apparent from the description and drawings, and from the claims.

### BRIEF DESCRIPTION OF DRAWINGS

FIG. 1 is a schematic diagram showing a prior-art claiming network.

FIG. 2 is a schematic diagram showing BARC elements in a network, in accordance with one embodiment.

FIG. 3 is a flowchart of an AB claiming procedure, in accordance with one embodiment.

FIG. 4 is a flowchart of a CABA defense procedure, in accordance with one embodiment.

FIG. 5 is a flowchart of an Inquiry procedure, in accordance with one embodiment.

FIG. 6 is a flowchart of a Registrar procedure, in accordance with one embodiment.

FIG. 7 is a flowchart of an Advisor procedure, in accordance with one embodiment.

FIG. 8 is a flowchart of a offer reception procedure, in accordance with one embodiment.

FIG. 9 is a flowchart of a proposal reception procedure, in accordance with one embodiment.

FIG. 10 is a flowchart of a RABI claiming procedure, in accordance with one embodiment.

FIG. 11 is a flowchart of a RABI defense procedure, in accordance with one embodiment.

FIG. 12 is a flowchart of a Claimant/Advisor procedure, in accordance with one embodiment.

FIG. 13 is a flowchart of a Claimant/Registrar procedure, in accordance with one embodiment.

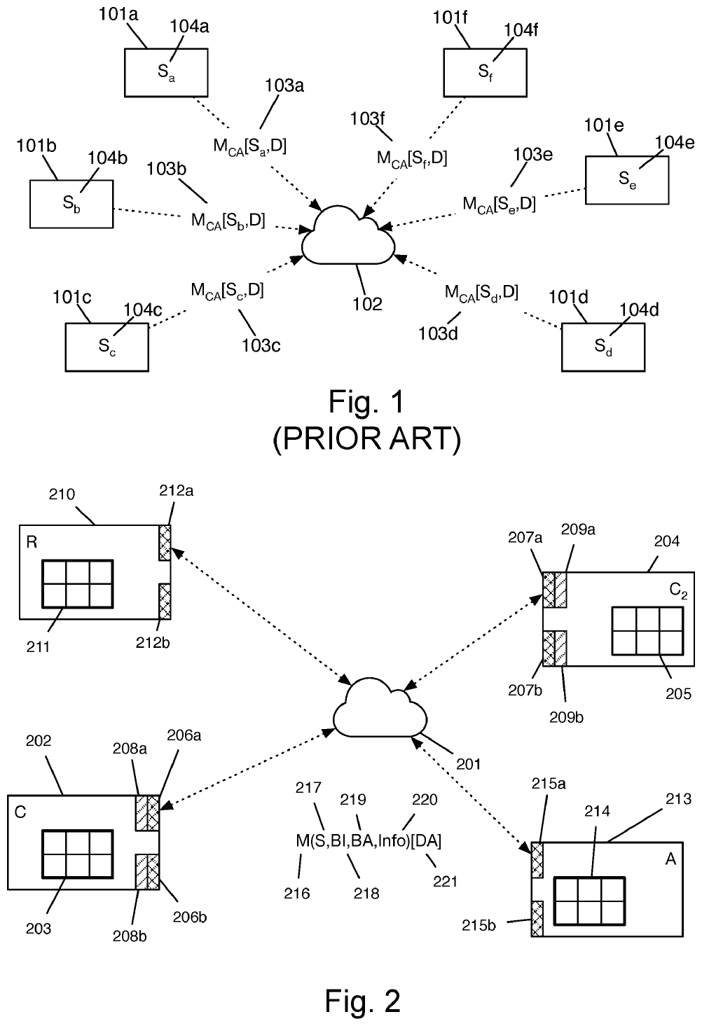

Like reference symbols in the various drawings indicate like elements.

### DETAILED DESCRIPTION

### Overview

Aspects of the current disclosure improve upon the prior art. For example:
Aspects of the disclosure significantly limit the number of announcements on the network so that they do not burden the network, even with a large number of claimants, by avoiding the need deliver announcements to each claimant for a conflict check.
Aspects of the disclosure significantly avoid the need for each claimant to be frequently interrupted by receiving each claim message and examining it for conflicts.
Aspects of the disclosure significantly simplify the examination of the claim message for conflicts and the communication of a defending claim message when the device's current claim set and/or the received claim message are complex; for example, when a claim includes both unicast and multicast address assignments or when a response identifies conflicts in some addresses but not others. While a prior-art claim set may be simplified in some cases by splitting it into multiple claim sets, that results in even more repeated claims.
Aspects of the disclosure also support the use of a registrar entity inventory maintaining an inventory of available assignments and a list of assignments made. Such a registrar entity may observe address claim messages and respond with an offer of addresses from its inventory. Such a structured process allows centralized registrars to manage address assignments according to configuration, which could be specified by a network manager. Also, use of the registrar may relieve claimants of the need to diligently defend their claims. The disclosure supports an innovative registration method and system to provide efficient address registration and management and frees claimants from the need to know, prior to a making claim, whether or not a registrar is available to respond to that claim.
Aspects of the disclosure allow a device to initiate the claiming and registration process even when it lacks an address prior to initiation.

This disclosure teaches the claiming and assignment of multiple addresses simultaneously, as an address claim block, each such claim block identifying a disjoint set of addresses, and teaches that a claimant sends a targeted announcement of its claim block to a multicast address that is coded to identify the claim block. As a result, it is sufficient for a claimant to listen for the multicast address that identifies its own claim but not to multicast addresses that identify claims to which it is not a party. Furthermore, if a registrar observes such a claim, it can respond with an offer of an available claim from its inventory.

One consequential advantage of this approach is that a claimant can quickly and efficiently dispense with examining claim announcements if the indicated claim does not identify its own claims.

Another consequential advantage of this approach is that the network may, by well-known means, limit its forwarding of claim announcements to devices with an interest in receiving messages to the multicast address identifying the claim.

Another consequential advantage of this approach is the simplification of analysis of claim conflicts and simplification of messaging, including response messaging.

Another consequential advantage of this approach is that multiple registrars, if provided in the network, are enabled to efficiently obtain disjoint inventories and allow efficient centralized control of address assignments to claimants that are not required to know in advance of the existence of registrars.

Various embodiments of the invention will now be described by way of example and with reference to the drawings. However, it should be realized that this is not an exhaustive description of all possible embodiments, and that there are many other embodiments and variations that fall within the scope of the appended claims, and which can be realized by those persons having ordinary skill in the art.

### Example Embodiments

FIG. 2 shows schematic diagram showing BARC elements in a network, in accordance with one embodiment. The embodiment shown in FIG. 2 includes two claimants, First Claimant (202) and Second Claimant (204). Each claimant is equipped with an Address Block Designation (ABD) database into which the claimant can record and from which the claimant can recall address block designations along with information about those address block designations. In particular, First Claimant (202) is equipped with First Claimant ABD database (203) and Second Claimant (204) is equipped with Second Claimant ABD database (205).

Each claimant is equipped with one or more ports. In particular, First Claimant (202) is equipped with one or more of First Claimant Port (206); as an example, two first claimant ports are shown in FIGS. 2 as (206a) and (206b). Likewise, Second Claimant (204) is equipped with one or more of Second Claimant Port (207); as an example, two second claimant ports are shown in FIGS. 2 as (207a) and (207b). The Ports may be physical interfaces, such as cable interconnection points, or may be logical interfaces.

Each claimant can send frames to forwarding network (201) multiple times and determine the contents of each such frame. The claimant in enabled to specify the egress port by reference to a local port identifier.

Each claimant port is equipped with a configurable ingress filter. In particular, first Claimant ports (206a) and (206b) are each equipped with a first Claimant ingress filter (208), illustrated in FIGS. 2 as (208a) and (208b), respectively. Likewise, Second Claimant ports (207a) and (207b) are each equipped with a Second Claimant ingress filter (209), illustrated in FIGS. 2 as (209a) and (209b), respectively. Each claimant is enabled to set each of its ingress filters to specify the destination addresses, or sets of destination addresses, that will be processed by that claimant following receipt at that port. Frames arriving at a port from forwarding network (201) whose destination address is not set to pass the ingress filter for that port are not processed by that claimant according to the procedures described herein. In an embodiment, the ingress filters block such frames at the port solely on the basis of the destination address, without further processing. For example, the ingress filter may be incorporated in a network interface card, commonly known as a NIC. In other embodiments, the ingress filter may be virtual and implemented on frames that pass the NIC.

Forwarding network (201) is enabled to forward frames to other attached devices via their ports. Per conventional network operation, forwarding network (201) is enabled to forward such frames for receipt by some other elements in forwarding network (201), including claimants and registrars, typically with the exception of the transmitting element, following transmission to forwarding network (201) from another element.

In some embodiments, Registrar (210) is provided on forwarding network (201), as illustrated in FIG. 2. Each such Registrar (210) is equipped with a RABI database (211) into which Registrar (210) can record and from which Registrar (210) can recall Registrable Address Block Identifiers (RABIs) along with information about those RABIs. Registrar (210) is equipped with one or more ports. In particular, Registrar (210) is equipped with one or more Registrar Ports (212); as an example, two of these registrar ports are shown in FIGS. 2 as (212a) and (212b). Ports may be physical interfaces, such as cable interconnection points, or may be logical interfaces. Registrar (210) can send frames to forwarding network (201) and to determine the contents of each such frame. When a frame ingresses from forwarding network (201), Registrar (210) can identify the ingress port of arrival using a local port identification scheme.

In some embodiments, an Advisor (213) is provided on forwarding network (201), as illustrated in FIG. 2. Advisor (213) is equipped with a PABD database (214) into which Advisor (213) can record and from which Advisor (213) can recall PADB values. Advisor (213) is equipped with one or more ports. In particular, Advisor (213) is equipped with one or more Advisor Ports (215); as an example, two of these advisor ports are shown in FIGS. 2 as (215a) and (215b). Ports may be physical interfaces, such as cable interconnection points, or may be logical interfaces. Advisor (213) is enabled to send frames to forwarding network (201) multiple times and to determine the contents of each such frame. When a frame ingresses from forwarding network (201), Advisor (213) is enabled to identify the ingress port of arrival using a local port identification scheme.

While, for convenience of illustration, FIG. 2 shows only two Claimants (202, 204), one Registrar (210), and one Advisor (213), no limitation on the number of such elements is to be implied. The general techniques described herein can be applied to environments with one or more Claimants, zero or more Registrars, and zero or more Advisors.

As explained, claimants (202, 204), Registrar (210), and Advisor (213) are connected to a forwarding network (201) and enabled to exchange frames. Such a frame can contain a BARC message, in which case the frame is referred to as a BARC frame. Herein, the term “message” may in some cases refer to the frame containing the message. FIG. 2 illustrates a BARC message (216).

The content of the BARC message is indicated parenthetically in FIG. 2 and includes several parameters, the values of which may vary and are set by the sender of the message. The parameters include a state parameter (S field (217)), a block identifier parameter (BI field (218)), a block address parameter (BA field (219)), and an information parameter (Info field (220))

In addition to the BARC message, the BARC frame can include several other parameters, which may vary and are set by the sender to support the delivery of the BARC message. The only one of these parameters illustrated in FIG. 2 is destination address DA (221) of the frame.

Herein, references to the type of BARC message (216) may indicate the value of S field (217) designated therein. In particular, a BARC message indicating that S field (217) is set to “Discover” (abbreviated “D”) is called a Discover message, a BARC message indicating that S field (217) is set to “Claimed” (abbreviated “C”) is called a Claimed message, a BARC message indicating that S field (217) is set to “Offer” (abbreviated “O”) is called an Offer message, a BARC message indicating that S field (217) is set to “Request” (abbreviated “Q”) is called a Request message, a BARC message indicating that S field (217) is set to “Register” (abbreviated “R”) is called a Register message, a BARC message indicating that S field (217) is set to “Inquiry” (abbreviated “I”) is called an Inquiry message, and a BARC message indicating that S field (217) is set to “Proposal” (abbreviated “P”) is called a Proposal message.

In an embodiment, the parameter carried in BI field (218) specifies either an Address Block Designation (ABD) or a Proposed Address Block Designation (PABD). In an embodiment, the ABD is either a Claimable Address Block Address (CABA) or a RABI. In an embodiment, the PABD is either a CABA or a Proposed Address Block Identifier (PRABI).

In an embodiment, a set of claimable address blocks (CABs) is made available for claiming under the restriction that no address is included in more than one CAB. As a result, the CABs are disjoint, and no address conflicts are possible as long as addresses are drawn from different CABs. Accordingly, the complexity of comparing two claims for possible address duplication is simplified to the problem of determining whether the two claims both claim the same CAB.

In an embodiment, a CABA uniquely identifies each CAB among all CABs. Accordingly, the complexity of comparing two claims for possible address duplication is simplified to the problem of determining whether the two CABAs are identical.

In an embodiment, the CABA of each CAB takes the form of a multicast address, and a claim to a CAB is announced to the network in a BARC message addressed to a multicast destination address equal to the CABA of that CAB. Accordingly, a claimant need not listen for a BARC message addressed to any CABA except one identifying one of that claimant's own CABs. Messages addressed to that CABA are indicative of a potential address conflict within the CABA's address block, but messages addressed to a different CABA are not indicative of a potential address conflict. Accordingly, the problem of interruption of the claimant by claims of no relevance of the claimant is solved.

In an embodiment, forwarding network (201) is enabled to selectively filter an incoming BARC frame addressed to a CABA so as to forward the incoming BARC frame only to a claimant whose claim block CABA matches the destination. This does not affect the operation, since the claim is of no relevance to those other claimants and would be ignored or filtered by them. This solves the problem of burden to the network due to its delivery of excessive claim messages, since irrelevant BARC messages are not delivered.

For example, First Claimant (202) announces a tentative claim of an address block identified by CABA CABA₁ by sending a BARC message (216), with BI field (218) set to CABA₁ and S field (217) set to value “D” indicative of a Discover state, to DA (221) also set to CABAL. Thereby, the Discover message indicates the specific address block of the claim and is sent to a multicast address that uniquely identifies the particular claimed address block.

In one embodiment, a BARC message (216) includes no explicit identifier of the particular CABA except for its multicast destination address, which serves as the CABA identifier.

In one embodiment, a claimant makes a claim of a subset of an address block, identifying that subset in the content of the BARC message. In one embodiment, a claimant receiving this message and holding a claim to the address block identified in the message destination compares the message content to its own claim to determine whether an address conflict exists, taking remedial action if so.

In one embodiment, a set of Registrable Address Blocks (RABs), each including registrable addresses (RAs), is made available to the Registrar under the restriction that the RABs are disjoint from the CABs, so that no address is a member of both a RAB and a CAB, and subject to management processes to ensure that no two RABs in use by any claimant within forwarding network (201) share any common registrable addresses.

In one embodiment, for each RAB, a RAB identifier (a RABI) identifies that address block. In the embodiment detailed herein, the RABI is formatted similarly to, and the same size as, a network address but is not used as a network source or destination address.

In one embodiment, Registrar (210) is enabled to receive all BARC messages addressed to a CABA, including, for example, a Discover message. Registrar (210) is enabled to respond to a Discover message with an Offer message in which BI field (218) is set to the value of a RABI that it offers. After the claimant receives this message, it has the opportunity to issue a Request message for the offered RABI in a message sent for delivery to Registrar (210), which may respond with a Register message providing notification that the offered RABI has been registered for use.

In one embodiment, First Claimant (202) is enabled to send an Inquiry message, with a PABD in BI field (218) field, to an address at which reception by Registrar (210) or Advisor (213) is anticipated. This address could be, for example, a stored registrar or advisor Address, the standardized Nearest Customer Bridge (NCB) address or other scope-limited address of IEEE Std 802.1Q, or a null CABA. Advisor (213) can, upon receipt of an Inquiry message, respond with a Proposal message. The Proposal message can include a PABD, which may be selected specifically for the purposes of First Claimant (202). The Proposal message can include a proposed Registrar Address, to which First Claimant (202) could send a follow-up Inquiry message. Upon receipt of an Inquiry message, Registrar (210) can respond with an Offer message, similar to its response to a Discover message. Alternatively, Registrar (210) might respond as an advisor, for example, by sending a Proposal message with a referral to a different registrar by specification of its proposed Registrar Address.

In some embodiments, the functionality of some of First Claimant (202), Registrar (210), and Advisor (213) elements are combined into a single network device. For example, a First Claimant (202) device may also be enabled to serve as an Advisor (213), responding to Inquiry messages, and/or a Registrar (210), registering addresses to which that device has previously been assigned through claiming or registration. In one embodiment, First Claimant (202), Registrar (210), and Advisor (213) execute instructions based on those stored in a non-transitory computer-readable storage medium, as will be explained in further detail below.

### BARC Address Blocks

The following sections present detailed examples of embodiments in which a set of address blocks (which may include both claimable address blocks (CABs) and registrable address blocks (RABs)), is made available for assignment under the restrictions that no address is included in more than one CAB, no address in a CAB is included in any RAB, no address in a RAB is included in any CAB, an identifying address block designation (ABD) for each address block identifies only that address block among all address blocks, and the CAB's unique identifying CABA takes the form of a multicast address that is not itself a member of any of any CAB or RAB. In an embodiment, the ABD of each RAB is a RABI that is not a network address and not used as a network address and, while an address can be included in more than one possible RABI, registrars coordinate to ensure that no RABI is assigned in a network when an address conflict may exist with a different RABI in use within that network.

### BARC Address Formats

Table 1 illustrates a Layer 2 data frame address, considering the 48-bit address conventional in IEEE 802 networks. Table 1 illustrates that the 48-bit identifier can be decomposed into 6 octets (shown one per row, from most significant byte (MSB) to least significant byte (LSB)) or alternatively 12 nibbles (shown two per row), where a nibble is a 4-bit unit that can represented as a hexadecimal value in the range 0 through F. The nibble shown in the right column is the less significant nibble (LSN) of the byte; the more significant nibble (MSN) is on the left. Table 1 indicates that the first (i.e., most significant) byte comprises nibbles identified as N0 and N1, from more to less significance. The second byte comprises nibbles identified as N2 and N3, etc.

TABLE 1
Layer 2 Address

| | MSN | LSN |
|---|---|---|
| Byte 0 (MSB) | N0 | N1 |
| Byte 1 | N2 | N3 |
| Byte 2 | N4 | N5 |
| Byte 3 | N6 | N7 |
| Byte 4 | N8 | N9 |
| Byte 5 (LSB) | N10 | N11 |

Per convention and standardization, N1 is formatted so that its bits indicate the type of identifier. Table 2 illustrates the standard N1 format, where bit 0 is the least significant:

TABLE 2
N1 format

| | bit 3 | bit 2 | bit 1 | bit 0 |
|---|---|---|---|---|
| N1 | z | y | x | m |

The least significant bit of N1, designated m, is set to 0 for a unicast identifier and to 1 for a multicast identifier. Both unicast and multicast identifiers can be used in the various embodiments described herein.

The second least significant bit of N1, designated x, is set to 0 for a global identifier and to 1 for a local identifier. Since local identifiers are typically assigned for local purposes, the second least significant bit is presumed here to take the value 1. However, this is for example purposes only and does not limit the disclosure.

The third and fourth least significant bits of N10, designated y and z respectively, are standardized for the case in which x=1. For example, per IEEE Std 802c-2017, for local addresses that are specified per a standard, y and z are set to 1. These values of y and z are presumed for all addresses considered herein. However, this is for simplicity of example only and does not limit the disclosure.

Given that x, y, and z are set to 1, then N1 takes the hexadecimal value E (binary value 1110) for a unicast identifier (with m=0) and the value F (binary value 1111) for a multicast address (with m=1).

No format of nibbles N0-N11 is specified in pre-existing standardization. However, this disclosure indicates how nibbles N0-N11 may be usefully formatted for purposes of the disclosure.

In the example described below, N0 is comprised of bit values as shown in Table 3.

TABLE 3
N0 format

| | bit 3 | bit 2 | bit 1 | bit 0 |
|---|---|---|---|---|
| N0 | r | i | j | k |

As shown in Table 3, the most significant bit of N0 is designated r. The next bit is designated i, the second least significant bit of N0is designated j and the least significant bit of N2 is designated k.

In one embodiment, the contents of nibbles N0-N1 of a BARC address indicate the nature of the address, per Table 4.

TABLE 4
N0 and N1 coding

| | r | i | jk | m |
|---|---|---|---|---|
| RA | 1 | RABI Option | BABI Size | I/G |
| CA | 0 | 1 | CAB Size | I/G |
| CABA | 0 | 0 | CAB Size | 1 |
| TUA | 0 | 0 | 0 | 0 |

In particular:
when r=1, the address is a registrable address (RA), i.e., an address within an RAB; i indicates the RABI Option of the RAB's RABI; and the bit pair jk indicates the BABI Size of the RAB's RABI;
when r=0 and i=1, the address is a claimable address (CA); i.e., an address within a CAB, and jk indicates the CAB Size of the CAB's CABA;
when r=0, i=0, and m=1, the address is a CABA, and jk indicates the CAB Size; and
when r=0, i=0, and m=0, the address is a temporary unicast address (TUA), as described below.

A unicast RA is also known as an Individual RA (IRA). A multicast RA is also known as a Group RA (GRA). A unicast CA is also known as an Individual CA (ICA). A multicast CA is also known as a Group CA (GCA).

In one embodiment, the contents of nibbles N2-N11 of the identifier are formatted depending on the content of N0 and N1.

In one embodiment considered herein, the CAB is one of four sizes, as indicated by the bit pair jk. In particular, the CAB Size C is given by the value of this pair of bits; i.e., jk=00, 01, 10, and 11 indicates CAB Size C of 0, 1, 2, and 3, respectively.

In one embodiment illustrated herein, the content of nibble N2 is 0 for all CABAs and CAs, reserving addresses with non-zero N2 available for other uses. This restriction is not a limitation of the BARC method.

Table 5 illustrates, for the four CAB Sizes, how the CABA may be constructed and shows the associated Claimable Address Blocks (CABs). Since r=0, i=0, and m=1, the addresses in the CABA columns are each identifiable as a CABA. To the right of each CABA, Table 5 indicates Claimable Addresses (CAs) in the CAB identified by the adjacent CABA. For the CAB, nibble NO is identical to the corresponding CABA nibble, except that i=1 for the CAB. In CAB nibble N1, m is indicated as “*”, representing a “wildcard” value that may take any of the possible values; in this case, m can be 0 (indicating a unicast address) or 1 (indicating a multicast address). The nibble N2 is shown to hold the value 0 for each CABA and CAB, per the embodiment noted earlier. The nibbles N3-N11 are shown to hold the values X3-X11, or 0. When a value X3-X11 in indicated, that value is identical in the CABA and its corresponding CAB. When a value 0 is indicated for CABA nibbles N3-N11, the corresponding CAB nibble is indicated as “*”; this is a “wildcard” indicator signifying that the CAB includes CAs with any hexadecimal value, from 0 through F, in that nibble.

TABLE 5
CABA and CAB, CAB Size 0-3

| | CAB Size C = 0 | | | | | | | | CAB Size C = 1 | | | | | | | | CAB Size C = 2 | | | | | | | | CAB Size C = 3 | | | | | | | |
|---|---|---|---|---|---|---|---|---|---|---|---|---|---|---|---|---|---|---|---|---|---|---|---|---|---|---|---|---|---|---|---|---|
| | CABA | | | | CAB | | | | CABA | | | | CAB | | | | CABA | | | | CAB | | | | CABA | | | | CAB | | | |
| N0 | 0 | 0 | 0 | 0 | 0 | 1 | 0 | 0 | 0 | 0 | 0 | 1 | 0 | 0 | 0 | 1 | 0 | 0 | 1 | 0 | 0 | 0 | 1 | 0 | 0 | 0 | 1 | 1 | 0 | 0 | 1 | 1 |
| N1 | 1 | 1 | 1 | 1 | 1 | 1 | 1 | * | 1 | 1 | 1 | 1 | 1 | 1 | 1 | * | 1 | 1 | 1 | 1 | 1 | 1 | 1 | * | 1 | 1 | 1 | 1 | 1 | 1 | 1 | * |
| N2 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |

| | | | | | | | | |
|---|---|---|---|---|---|---|---|---|
| N3 | X3 | X3 | X3 | X3 | X3 | X3 | X3 | X3 |
| N4 | X4 | X4 | X4 | X4 | X4 | X4 | X4 | X4 |
| N5 | X5 | X5 | X5 | X5 | X5 | X5 | X5 | X5 |
| N6 | X6 | X6 | X6 | X6 | X6 | X6 | X6 | X6 |
| N7 | X7 | X7 | X7 | X7 | X7 | X7 | X7 | X7 |
| N8 | X8 | X8 | X8 | X8 | X8 | X8 | X8 | X8 |
| N9 | X9 | X9 | X9 | X9 | X9 | X9 | 0 | * |
| N10 | X10 | X10 | X10 | X10 | 0 | * | 0 | * |
| N11 | X11 | X11 | 0 | * | 0 | * | 0 | * |

Table 5 illustrates the CABA of Size C=0 and its corresponding C=0 Claimable Address Block (CAB), with jk=00. The nibbles N3-N11 of the CAB are shown to hold the values X3-X11, which are identical to the corresponding values of the nibbles N3-N11 for the corresponding CABA; each of these values may be any hexadecimal value, from 0 through F. Each Size 0 CAB includes a single unicast address and a single multicast address differing from a unicast address only in the m bit.

Table 5 illustrates the CABA of Size C=1 and its corresponding C=1 CAB, with jk=01. The nibbles N3-N10 of the CAB are shown to hold the values X3-X10, which are identical to the corresponding values of the nibbles N3-N10 for the corresponding CABA. Nibble N11 is indicated as “*”, representing a “wildcard” value that may take any value; in this case, any of the 16 values from 0 through F. Therefore, for the CAB Size 1 illustrated, the CAB includes 16 unicast addresses and 16 multicast addresses, each differing from a unicast address only in the m bit.

Table 5 illustrates the CABA of Size C=2 and its corresponding C=2 CAB, with jk=10. The nibbles N3-N9 of the CAB are shown to hold the values X3-X9, which are identical to the corresponding values of the nibbles N3-N9 for the corresponding CABA. Nibbles N11 and N10 are indicated as “*”, representing a “wildcard” value that may take any value. Therefore, for the CAB Size 2 illustrated, the CAB includes 256 unicast addresses and 256 multicast addresses, each differing from a unicast address only in the m bit.

Table 5 illustrates the CABA of Size C=3 and its corresponding C=3 CAB, with jk=11. The nibbles N3-N8 of the CAB are shown to hold the values X3-X8, which are identical to the corresponding values of the nibbles N3-N8 for the corresponding CABA. Nibbles N9-N11 are indicated as “*”, representing a “wildcard” value that may take any value. Therefore, for the CAB Size 3 illustrated, the CAB includes 4096 unicast addresses and 4096 multicast addresses, each differing from a unicast address only in the m bit.

To summarize the CABA:
the CABA is both an ABD (indicating its CAB uniquely) and a multicast network address;
the CABA indicates the CAB uniquely;
jk indicates the CAB Size C in the CABA and in the indicated CAB;
the C least significant nibbles of the CABA are 0;
in the C least significant nibbles of the CAB, all values 0-F are allowed;
each CAB subblock consequently includes 16^{C} contiguous addresses)
each CAB includes a unicast subblock and a multicast subblock; and
no CA within a CAB is within any other CAB (that is, a CAB with a different CABA).

Analysis of the CABA determines the following useful CABA functions.

The CAB Size C of X, where X is a CABA or CA, is given by C(X):

C(X)=(X&0x300000000000)/0x100000000000 (1)

The CABA of a CA is

CABA(CA)=CA)=CA& Cₘₐₛₖ(C(CA)) (2)

where

Cₘₐₛₖ(C)=˜(0x410000000000+(0x10)^{C}−1) (3)

A CA is within CABAₓ if and only if

CABA(CA)=CABAₓ. (4)

Note that Equation (4) is false unless C(CA)=C(CABAₓ).

The CAB of CABAₓ is the set of all CAs that satisfy Equation (4).

Analysis of the CABA determines expressions for its smallest unicast CA ICAₘᵢₙ, its largest unicast CA ICAₘₐₓ, its smallest multicast CA GCAₘᵢₙ, and its largest multicast GCAₘₐₓ:

ICAₘᵢₙ(CABA)=CABA|0x400000000000 (5)

ICAₘₐₓ(CABA)=ICAₘᵢₙ(CABA)+(0x10)^{C(CABA)}−1 (6)

GCAₘᵢₙ(CABA)=CABA|0x410000000000 (7)

GCAₘₐₓ(CABA)=GCAₘᵢₙ(CABA)+(0x10)^{C(CABA)}−1 (8)

Here, and in similar functions throughout this disclosure, “&” indicates the bitwise “AND”, “|” indicates the bitwise “OR”, “˜” indicates the bitwise “NOT”, the prefix “0x” indicates a hexadecimal number following, and “/” indicates arithmetic division.

In each CAB and CABA discussed to this point, r=0. As noted earlier, r=0 is used to indicate claimable ABs. Registrable ABs (RABs), in contrast, use r=1 (see Table 4) and can be registered by a Registrar. Registrars are assigned inventories of RABIs, which can be registered to individual Claimants. Such inventories are represented in terms of RABIs. Each RABI identifies one and only one RAB. Unlike the CABA, the RABI is not used as a network address and therefore need not be arranged to be distinct from network addresses. However, for convenience of operation, in the embodiment described herein the RABI is of length 6 bytes, matching the length of the network addresses.

As disclosed below, a RABI can aggregate other RABIs. The level of aggregation is described with a parameter known as the Multiple Address Block Indicator (MABI) Size. A RABI is characterized by its Basic Address Block Indicator (BABI) Size B, as expressed in the bit pair jk of N0 and its MABI Size M, as expressed as the value of N1. The RABI is also characterized by its RAB Size R, which is the sum of these: R=B+M.

The following tables illustrate how the RABI may be constructed to provide these properties. Table 6 illustrates, in the case of MABI Size M=0 and BABI Size B from 0 through 3, the RABI along with the corresponding RAB. For each RAB, nibble N1 is structured the same as N1 of a CAB. For each RAB, nibble NO is structured similarly to that of NO of a CAB; however, for the RABI, r=1, and i may be either 0 or 1, with an identical value of i in the RABI and in the RAB that it identifies. The j and k bits are analogous to the CABA case; the pair jk indicates the BABI size B and the number of “wildcard” nibbles when the MABI Size is 0.

TABLE 6
RABI and RAB, BABI Size 0-3, with MABI Size = 0

| | BABI Size 0 | | | | | | | | BABI Size 1 | | | | | | | | BABI Size 2 | | | | | | | | BABI Size 3 | | | | | | | |
|---|---|---|---|---|---|---|---|---|---|---|---|---|---|---|---|---|---|---|---|---|---|---|---|---|---|---|---|---|---|---|---|---|
| | RABI | | | | RAB | | | | RABI | | | | RAB | | | | RABI | | | | RAB | | | | RABI | | | | RAB | | | |
| N0 | 1 | i | 0 | 0 | 1 | i | 0 | 0 | 1 | i | 0 | 1 | 1 | i | 0 | 1 | 1 | i | 1 | 0 | 1 | i | 1 | 0 | 1 | i | 1 | 1 | 1 | i | 1 | 1 |
| N1 | 0 | 0 | 0 | 0 | 1 | 1 | 1 | * | 0 | 0 | 0 | 0 | 1 | 1 | 1 | * | 0 | 0 | 0 | 0 | 1 | 1 | 1 | * | 0 | 0 | 0 | 0 | 1 | 1 | 1 | * |

| | | | | | | | | |
|---|---|---|---|---|---|---|---|---|
| N2 | X2 | X2 | X2 | X2 | X2 | X2 | X2 | X2 |
| N3 | X3 | X3 | X3 | X3 | X3 | X3 | X3 | X3 |
| N4 | X4 | X4 | X4 | X4 | X4 | X4 | X4 | X4 |
| N5 | X5 | X5 | X5 | X5 | X5 | X5 | X5 | X5 |
| N6 | X6 | X6 | X6 | X6 | X6 | X6 | X6 | X6 |
| N7 | X7 | X7 | X7 | X7 | X7 | X7 | X7 | X7 |
| N8 | X8 | X8 | X8 | X8 | X8 | X8 | X8 | X8 |
| N9 | X9 | X9 | X9 | X9 | X9 | X9 | 0 | * |
| N10 | X10 | X10 | X10 | X10 | 0 | * | 0 | * |
| N11 | X11 | X11 | 0 | * | 0 | * | 0 | * |

The structure of the RABI N1 nibble, however, is completely different from that of the CABA. Since the RABI is not a network address, the RABI does not need to conform to standards that specify N1 of a network address. Nibble N1 is set to indicate the RABI's MABI Size. Since Table 6 is limited to MABI Size M=0, N1=0 for all RABIs in that table.

Table 7 illustrates RABI aggregation according to the MABI Size. The example is of four RABIs, and their associated RABs, all with BABI Size B=3. The first example, on the left, shows MABI Size M=0, so it repeats the right-hand example of Table 6. The other three examples illustrate M=1, M=2, and M=7. As shown in the examples, M is indicated by the value of N1. In the figure, the symbol “#” indicates a wildcard that takes any value, functioning identically to the “*” symbol. The symbol differentiation is used only for clarity of explanation, because the “#” nibbles are associated with the aggregation indicated by M, while the “*” nibbles are associated with the aggregation indicated by the BABI Size B. As shown in each case, the number of least-significant nibbles set to 0 in the RABI, and to a wildcard value in the associated RAB, is equal to R=B+M; B wildcard nibbles associated with the BABI Size B (=jk) and M wildcard nibbles associated with the MABI Size M (the value of N1).

TABLE 7
Aggregation Example: BABI Size 3, various MABI Sizes

| | MABI Size 0 | | | | | | | | MABI Size 1 | | | | | | | | MABI Size 2 | | | | | | | | | MABI Size 7 | | | | | | | |
|---|---|---|---|---|---|---|---|---|---|---|---|---|---|---|---|---|---|---|---|---|---|---|---|---|---|---|---|---|---|---|---|---|---|
| | RABI | | | | RAB | | | | RABI | | | | RAB | | | | RABI | | | | RAB | | | | | RABI | | | | RAB | | | |
| N0 | 1 | i | 1 | 1 | 1 | i | 1 | 1 | 1 | i | 1 | 1 | 1 | 0 | 1 | 1 | 1 | i | 1 | 1 | 1 | i | 1 | 1 | . . . | 1 | i | 1 | 1 | 1 | i | 1 | 1 |
| N1 | 0 | 0 | 0 | 0 | 1 | 1 | 1 | * | 0 | 0 | 0 | 1 | 1 | 1 | 1 | * | 0 | 0 | 1 | 0 | 1 | 1 | 1 | * | | 0 | 1 | 1 | 1 | 1 | 1 | 1 | * |

| | | | | | | | | |
|---|---|---|---|---|---|---|---|---|
| N2 | X2 | X2 | X2 | X2 | X2 | X2 | 0 | # |
| N3 | X3 | X3 | X3 | X3 | X3 | X3 | 0 | # |
| N4 | X4 | X4 | X4 | X4 | X4 | X4 | 0 | # |
| N5 | X5 | X5 | X5 | X5 | X5 | X5 | 0 | # |
| N6 | X6 | X6 | X6 | X6 | X6 | X6 | 0 | # |
| N7 | X7 | X7 | X7 | X7 | 0 | # | 0 | # |
| N8 | X8 | X8 | 0 | # | 0 | # | 0 | # |
| N9 | 0 | * | 0 | * | 0 | * | 0 | * |
| N10 | 0 | * | 0 | * | 0 | * | 0 | * |
| N11 | 0 | * | 0 | * | 0 | * | 0 | * |

Note that the number of wildcard nibbles is limited to the largest B (3) plus the largest M (7), which sums to 10. This matches the number of wildcard nibbles available (10, from N2 through N11). The example on the right of Table 6 shows that largest possible RAB Size, 10.

To summarize the RABI:
the RABI is an ABD and is never a network address;
the RABI indicates the RAB uniquely, but the RAB does not indicate its RABI uniquely;
i indicates the RABI Option, so that RABI Options 0 and 1 provide independent RABIs and matching independent RABs;
jk indicates the BABI Size B in the RABI and in the indicated RAB;
the RABI's nibble N1 value indicates the MABI Size M;
M is not indicated in the RAB;
the RAB Size R=B+M;
the R least significant nibbles of the RABI are 0;
in the R least significant nibbles of the RAB, all values 0 through F are allowed;
each RAB subblock consequently includes 16^{R} contiguous addresses; and
each RAB includes a unicast subblock and a multicast subblock, differing in m.

Analysis of the RABI structure results in the conclusion that a RABI may aggregate other RABIs and that a RABI of RAB Size R and MABI Size M can be disaggregated into:
16 RABIs of RAB Size R-1 (MABI Size M-1)
16² RABIs of RAB Size R-2 (MABI Size M-2)
16^{R-n} RABIs of RAB Size R-n (MABI Size M-n)
. . .
16^{M}RABIs of RAB Size B (MABI Size 0)

Furthermore:
A RABI of RAB Size B (MABI Size 0) cannot be disaggregated.
An RA appears in one and only RABI of each M.

Analysis of the RABI determines the following useful RABI functions.

The BABI Size B of X, where X is a RABI or RA, is given by B(X):

B(X)=(X&0x300000000000)/0x100000000000 (9)

The MABI Size M of a RABI is given by M(RABI):

M(RABI)=(RABI&0x070000000000)/0x010000000000 (10)

The RAB Size R of a RABI is given by R(RABI):

R(RABI)=B(RABI)+M(RABI) (11)

A particular RA RA_{y} is within a particular RABI RABIₓ if and only if

RA_{y}& Rₘₐₛₖ(R(RABIₓ))=RABIₓ& Rₘₐₛₖ(R(RABIₓ)) (12)

where

Rₘₐₛₖ(N)=0x0F0000000000+(0x10)^{N}−1) (13)

The RAB of RABIₓ is the set of all RAs that satisfy Equation (12).

A particular RABI RABI_{z} shares RAs with a particular RABI RABIₓ if and only if

RABI_{z}& Rₘₐₛₖ(R(RABIₓ))=RABIₓRₘₐₛₖ(R(RABI_{z})) (14)

Equation (14) is always false if the two RABI Options differ or the two BABI Sizes differ.

Analysis of the RABI determines expressions for its smallest unicast RA IRAₘᵢₙ, its smallest multicast RA GRAₘᵢₙ, its largest unicast RA IRAₘₐₓ, and its largest multicast GRAₘₐₓ:

IRAₘᵢₙ(RABI)=RABI&0xF0FFFFFFFFFF+0x0E0000000000 (15)

GRAₘᵢₙ(RABI)=RABI&0xF0FFFFFFFFFF+0x0F0000000000 (16)

IRAₘₐₓ(RABI)=IRAₘᵢₙ(RABI)+(0x10)^{R(RABI)}−1 (17)

GRAₘₐₓ(RABI)=GRAₘᵢₙ(RABI)+(0x10)^{R(RABI)}−1 (18)

Analysis of the RABI determines that an RA exists in one and only one RABI of each MABI Size M, called RABI_{M}(RA,M), and that a RABI exists in one and only one aggregated RABI of each larger MABI Size M, called RABI_{M}(RABI,M), where:

RABI_{M}(X,Mₙ)=X&Rₘₐₛₖ(Mₙ+B(X))+Mₙ(X)*0x010000000000 (19)

RABIs of most sizes include nibbles fixed to the value 0. These nibbles convey no information. In some embodiments, RABIs are specified so that data is included in those nibbles, thereby expanding the flexibility of the assignment of the RAB by the RABI without lengthening the RABI. For example, the nibbles heretofore described as set to 0 could be replaced by information that, when non-zero, can either expand or shrink the size of RAB identified by the RABI. For example, those bits could be replaced by a bit mask applicable to the specified nibbles above, such that a 1 would represent a “don't care” regarding the associated bit. For instance, in an embodiment, the BABI Size 3, MABI Size 1 RABI of Table 7 is generalized so that the bits of nibbles N8-N11 form a bit mask that is applied to corresponding nibbles X4-X7 such that a 1 in one of the nibbles N8-N11 indicates that the RAB includes both values of the corresponding bit of the corresponding nibble (i.e., the one that is 4 nibbles above).

In some embodiments, a set of addresses is specified for use a non-claim Temporary Unicast Addresses (TUAs). In an embodiment, the TUAs are specified as illustrated in Table 8. The wildcard symbol “*” indicates that the set of nonclaim unicast addresses includes all possible values of the indicated nibble. In some embodiments, a non-claim unicast address, sometimes selected randomly from the set, is used as a temporary address by a claimant that lacks a preassigned unicast address to include as a message source address. In some embodiments, alternate values of bits in the nibbles N2 and N0 may be allowed; for example, wildcard values of N2 and bits j and k may be allowed.

In some embodiments, a null CABA (CABA₀) of each CAB Size is specified,

TABLE 8
Temporary Unicast Addresses (TUAs)

| nibble | value |
|---|---|
| N0 | 0 |
| N1 | 1110 |
| N2 | 0 |
| N3 | * |
| N4 | * |
| N5 | * |
| N6 | * |
| N7 | * |
| N8 | * |
| N9 | * |
| N10 | * |
| N11 | * |

as illustrated in Table 9. The null CABA is not an assignable address. No claimant is required to listen for frames destined to that address, although a Registrar is required to do so. The null CABA may be used as the destination address of BARC Inquiry; e.g., when a Registrar address is unknown.

TABLE 9
null CABA (CABA₀)

| nibble | value |
|---|---|
| N0 | 0 |
| N1 | 1111 |
| N2 | 0 |
| N3 | 0 |
| N4 | 0 |
| N5 | 0 |
| N6 | 0 |
| N7 | 0 |
| N8 | 0 |
| N9 | 0 |
| N10 | 0 |
| N11 | 0 |

A format of Proposed RABIs (PRABIs) is specified for use in the content of a BARC Inquiry or BARC Proposal message. In some embodiments, only RABIs are used as PRABIs, and a PRABI is used to propose the identical RABI. In other embodiments, the PRABI includes information in the R least significant nibbles that are fixed as 0 in the corresponding RABI. In those cases, the PRABI indicates a set of RABIs whose RABI Option, RAB Size, and BABI Size match those of the PRABI, while the requested nibble values (excluding the R least significant nibbles) of the RABI are based on the corresponding nibble values of the PRABI and possibly on the R least significant nibbles of the PRABI as well.

In one embodiment, the bits of the nibbles heretofore described as set to 0 are in some embodiments replaced by a bit mask applicable to specified nibbles above, such that a 0 represents a “don't care” regarding the associated bit. The mask nibbles are restricted to the R_{cap}(PRABI) least significant nibbles, where

R_{cap}(X)=min(R(X), 10−R(X))) (20)

This ensures that each mask nibble has a corresponding RABI nibble above to mask. For example, if R32 6, then six nibbles are available to contain mask information, but only four nibbles are maskable, so the mask is limited to the R_{cap}=4 least significant nibbles. The implementation makes use of the mask and shift function:

Pₘₐₛₖ(X)=(0x10)^{R(X)}*X&((0x10)^{Rcap(X)}−1) (21)

which selects only the R_{cap} least significant nibbles and then shifts them left by R hexadecimal digits. Finally, the PRABI refers to any RABI that satisfies:

RABI|Pₘₐₛₖ(PRABI)=[PRABI&˜((0x10)^{R(PRABI)}−1)]|Pₘₐₛₖ(PRABI) (22)

In some embodiments, a null RABI/null PRABI of each BABI Size and MABI Size is specified for use, as illustrated in Table 10. When used as a PRABI in a BARC Inquiry or BARC Proposal message, the null PRABI indicates only that the requested RABI Option is the value i, the requested BABI Size is the value jk, and the requested MABI Size is M. When used as a RABI in a BARC Offer message, the null RABI conveys to the claimant that no RABI is offered.

TABLE 10
null RABI/null PRABI

| nibble | value |
|---|---|
| N0 | l i j k |
| N1 | M |
| N2 | 0 |
| N3 | 0 |
| N4 | 0 |
| N5 | 0 |
| N6 | 0 |
| N7 | 0 |
| N8 | 0 |
| N9 | 0 |
| N10 | 0 |
| N11 | 0 |

### Operation

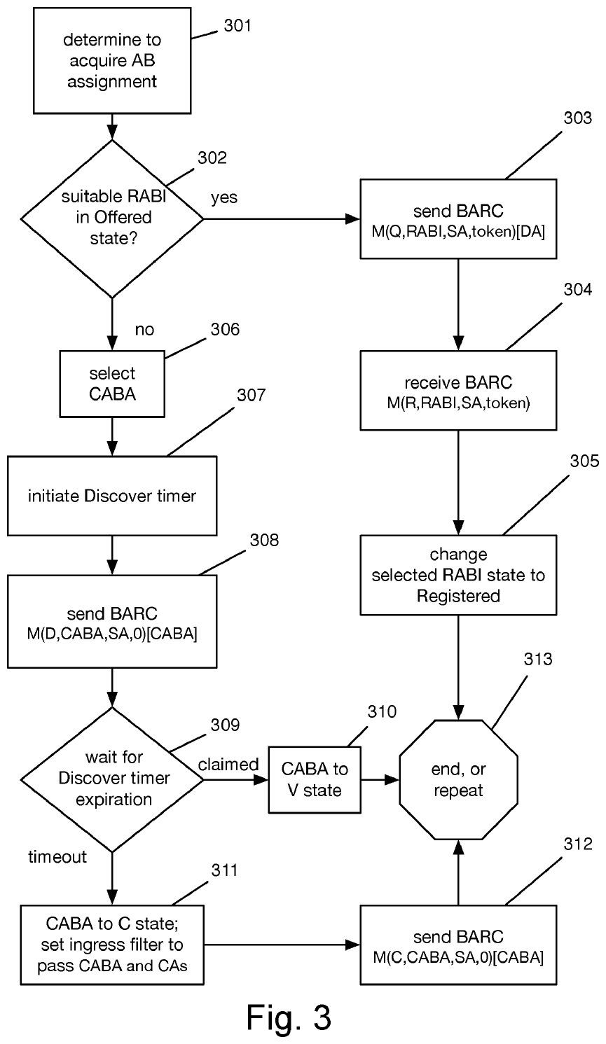

FIG. 3 is a flowchart of an AB claiming procedure, in accordance with one embodiment, showing steps performed by First Claimant (202).

As can be seen in FIG. 3, in Step (301), First Claimant (202) determines to acquire an AB assignment, which could be in addition to or a replacement of an existing AB assignment.

Next, in Step (302), First Claimant (202) determines, by examination of First Claimant ABD database (203), whether a RABI stored therein in the Offered state is suitable to meet the AB assignment need of Step (301). If the result is affirmative, then such a RABI is selected and the process continues to Step (303). If the result is negative, the process continues to Step (306).

In Step (303), the state of the RABI selected in Step (302) is changed to the Requested (Q) state in the First Claimant ABD database (203) , and First Claimant (202) sends a BARC message (216) (in particular, a Request message) to DA (221) associated with the selected RABI per the RABI database (211), indicating (in BI field (218)) the requested RABI and indicating (in S field (217)) that this RABI is in the Requested (Q) state. The source address (SA) of the frame of BARC message (216), which may be a TUA, may be stored in RABI database (211) for future messaging regarding that RABI and may be included as BA field (219) of BARC message (216). A token may be generated, included in Info field (220) field of the BARC message (216), and stored in RABI database (211) for future messaging regarding that RABI.

Next, in Step (304), First Claimant (202) receives a Register message, in response to the Request message of Step (303) and including the token if stored in Step (303), at the source address SA as specified in BA field (219) of the Request message of Step (303). This Register message indicates (in BI field (218)) the Registered RABI and indicates (in S field (217)) that this RABI is in the Registered (R) state. In some embodiments, First Claimant (202) may proceed directly to Step (305) and skip Step (304).

In Step (305), First Claimant (202) changes the state of the selected RABI in the RABI database (211) to Registered (R) and makes zero or more addresses in the RAB of that RABI available for use by First Claimant (202). This may include setting First Claimant ingress filter (208) to pass selected RAs of the RAB of the selected RABI at one or more First Claimant Port (206). In some embodiments, First Claimant (202) notifies the forwarding network (201) of its interest in receiving frames addressed to selected RAs, using methods such as the conventional Multiple Registration Protocol (MRP) of IEEE Standard 802.1Q. Subsequently, the AB claiming procedure terminates at Step (313), after which it may be repeated.

In Step (306), if it follows Step (302), First Claimant (202) selects a CABA to claim. This involves two sub-steps:
1. Select a CAB Size (a value of jk) sufficient to accommodate the number of addresses required. For the addressing structures as described above: for subblocks of one address, select CAB Size=0; for subblocks of 16 contiguous addresses, select CAB Size=1; for subblocks of 256 contiguous addresses, select CAB Size=2; for subblocks of 4096 contiguous addresses, select CAB Size=3. In each case, the address block will include one unicast subblock and one multicast subblock.
2. Considering the format of the CABA for each CAB Size, per Table 5, select a specific CABA by selecting specific values of X3-X11 (CAB Size=0), X3-X10 (CAB Size=1), X3-X9 (CAB Size=2), or X3-X8 (CAB Size=3). In some embodiments, each of these nibble values is selected randomly. In other embodiments, some or all nibble values are selected based on deterministic factors, such as, for example, the function or topological location of First Claimant (202), its neighbor addresses, or the purpose of the address. In some embodiments, previously assigned values may be recalled for reuse. A null CABA per Table 9 may be selected.

In Step (307), First Claimant (202) initiates a Discover timer, setting it to a specified value and initiating its countdown toward expiration.

Next, in Step (308), First Claimant (202) sets the state of the CABA (selected in Step (306)) to the Discover (D) state and sends a BARC message (216) (in particular, a Discover message), indicating in BI field (218) the selected CABA and in S field (217) that this CABA is in the Discover (D) state, using this CABA also as DA (221). BA field (219) field indicates the address of First Claimant (202), and Info field (220) field may be unused and may be set to 0.

In Step (309), First Claimant (202) waits for the Discover timer to expire. If, while waiting, First Claimant (202) receives a BARC message indicating that the selected CABA is in a Claimed state, then the “claimed” branch is followed and the AB claiming procedure continues with Step (310). Otherwise, when the Discover timer expires, the “timeout” branch is followed and Step (311) ensues.

In Step (310), First Claimant (202) sets the state of the CABA (set to the D state in Step (308)) in First Claimant ABD database (203) to the Vacant (V) state, or some other state indicating that it is no longer in Discover (D) state. Subsequently, the AB claiming procedure terminates at Step (313), after which it may be repeated.

In Step (311), First Claimant (202) sets First Claimant ingress filter (208) to pass the claimed CABA (of Step (308)) and to pass selected CAs within the CAB of that CABA; that CAB includes all CAs satisfying Equation (4), including unicast CAs ranging from ICAₘᵢₙ (Equation (5)) through ICAₘₐₓ (Equation (6)) and multicast CAs ranging from GCAₘᵢₙ (Equation (7)) through GCAₘₐₓ (Equation (8)). First Claimant (202) changes the state of the selected CABA in First Claimant ABD database (203) to Claimed (C) and makes selected CAs in the CAB of that CABA available for use by First Claimant (202). In some embodiments, First Claimant (202) notifies forwarding network (201) of its interest in receiving frames addressed to selected CAs, using methods such as the Multiple Registration Protocol (MRP) of IEEE Standard 802.1Q. Subsequently, the AB claiming procedure proceeds to Step (312).

In Step (312), First Claimant (202) sends a Claimed message (216), using the claimed CABA as DA (221), indicating (in BI field (218) and S field (217), respectively) that the claimed CABA is in the Claimed (C) state. BA field (219) field indicates the address of First Claimant (202), and Info field (220) field may be unused and may be set to 0. Subsequently, the AB claiming procedure terminates at Step (313), after which it may be repeated.

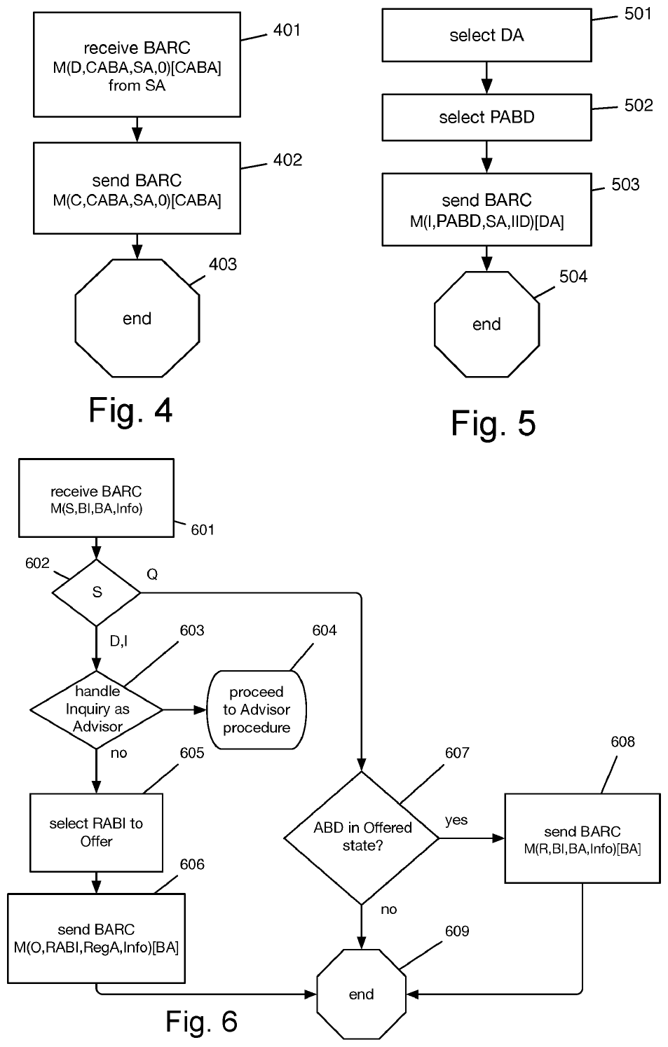

FIG. 4 is a flowchart of a CABA defense procedure, in accordance with one embodiment, in which Second Claimant (204) takes the following steps. In Step (401), Second Claimant (204), for which a CABA is in the Claimed (C) state and whose Second Claimant ingress filter (209) is set to pass that CABA, receives a BARC message (216) (in particular, a Discover message), addressed to that CABA, indicating (in BI field (218) and S field (217), respectively) that the CABA is in the Discover (D) state. That message may have originated at a claimant such as First Claimant (202) in Step (308); the address of First Claimant (202) is specified in BA field (219).

Next, in Step (402), Second Claimant (204) sends a BARC message (216) (in particular, a Claimed message), to First Claimant (202) (i.e., to BA field (219) of the message received in Step (401)), indicating (in BI field (218) and S field (217), respectively) that the selected CABA is in the Claimed (C) state. Subsequently, the CABA defense procedure terminates at Step (403).

First Claimant (202) takes the following steps in an Inquiry procedure, in accordance with one embodiment and as illustrated in FIG. 5. In Step (501), First Claimant (202) selects an Inquiry destination address for an inquiry, selected as an address at which First Claimant (202) anticipates a Registrar (210) or Advisor (213). Possible addresses include the null CABA (CABA₀), the standardized Nearest Customer Bridge Address (NCB) or other scope-limited address per IEEE Std 802.1Q, or an entry recalled from First Claimant ABD database (203). If First Claimant (202) is outfitted with more than one port, it may also select an egress port or ports from which to send the Inquiry.

In Step (502), First Claimant (202) selects a PABD indicating the characteristics of a RABI or CABA assignment that it seeks, in view of the RABI or CABA format, as illustrated in Tables 5, 6, and 7 and the associated explanatory text. In particular, it may select a PRABI with the RABI Option i, BABI Size B, and MABI Size M specifying the corresponding values of its requested RABI, while selecting other nibble values (excluding the R least significant nibbles, where R is the RAB Size B+M) of the PRABI to indicate the corresponding nibble values of the requested RABI. If First Claimant (202) does not care about the value of some bits in those nibbles, it specifies the “don't care” bits by specifying a bit mask within the R least significant nibbles, per Equation (22), or selects the null PRABI of Table 10. Alternatively, instead of a PRABI, First Claimant (202) may select a CABA as the PABD.

In Step (503), First Claimant (202) sends a BARC message to the Inquiry destination address and port(s) selected in Step (501), indicating the PABD selected in Step (502) as BI field (218) and Inquiry (I) as S field (217) of that PABD. BA field (219) field indicates the address of First Claimant (202). Info field (220) field contains an Inquiry Identifier (IID) that uniquely identifies the Inquiry among actives Inquiries issued by First Claimant (202). This concludes the Inquiry procedure (per Step 504).

In one embodiment, Registrar (210) takes the following steps in a Registrar procedure, which is illustrated in FIG. 6. In Step (601), Registrar (210) receives a BARC message indicating an BI field (218) and its S field (217). That message may have originated at First Claimant (202) in Step (303), Step (308), or Step (503); BI field (218) is then a RABI, CABA, or PRABI, respectively.

Next, in Step (602), Registrar (210) identifies S field (217) of Step (601), proceeding to Step (603) if that S field (217) indicates a Discover (D) or Inquiry (I) state and Step (607) if that S field (217) indicates an Requested (Q) state.

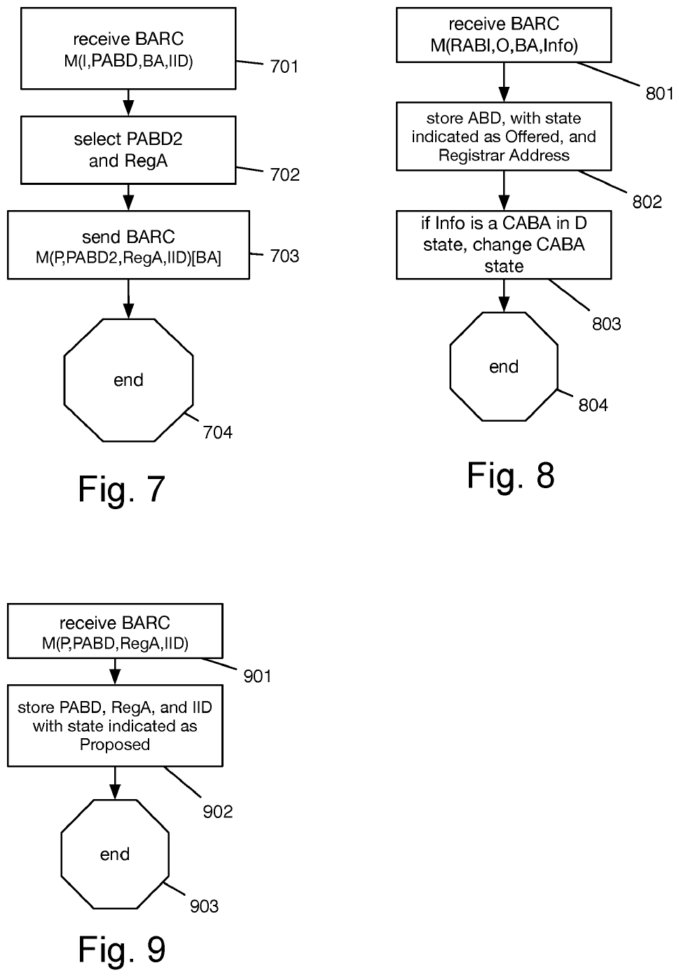

In Step (603), Registrar (210) considers whether, if S field (217) of the BARC message indicates an Inquiry (I) state, to respond to that message as an Advisor instead of as a Registrar. If so, then, Step (604) ensues, in which the BARC message of Step (601) is passed to the Advisor procedure, as illustrated in FIG. 7. If not, Step (605) follows.

In Step (605), Registrar (210) selects a RABI to offer from its available inventory, or a null RABI, in response to the Discover or Inquiry message of Step (601). In selecting the RABI, Registrar (210) may consider various aspects of the BARC message received in Step (601), including the local identifier of the port on which Registrar (210) received it and the Virtual LAN (VLAN) of that BARC message. The selection is drawn from existing RABIs in the SClaimed (SC) state within RABI database (211) (i.e., ensuring that Equation (14) is true with respect to one RABI in the inventory) while avoiding overlap with any RABI in the Registered (R) or Offered (O) state within the RABI database (211), thus ensuring that no RAB within the selected RABI has RAs in common with the RAB of any RABI in the Registered (R) state or Offered (O) state (i.e., ensuring that Equation (14) is false with respect to all such RABIs)). If Registrar (210) device also includes claimant functionality, then the inventory may also include RABIs held in Registered (R) state in its claimant ABD database. The RABI selection considers BI field (218) and S field (217) values of Step (601), in particular considering that:
if S field (217) of Step (601) is set to Discover (D), then BI field (218) is presumed to be a CABA, and the CAB Size is presumed to indicate the preferred RAB Size;
if S field (217) of Step (601) is set to Inquiry (I), then BI field (218) is presumed to be a PRABI and the request is indicated by the RABIs corresponding to that PRABI, per Equation (22).

Step (605) may be deferred pending additional input. Information regarding the BARC message received in Step (601), including the VLAN and the local identifier of the port on which Registrar (210) received it, may be stored until Registrar (210) is ready to continue.

In Step (606), Registrar (210) transitions the RABI selected in Step (605) (if not a null RABI) to the Offered (O) state in RABI database (211) and sends a BARC message (216) (in particular, an Offer message), to the source address of the message received in Step (601) (stored in BA field (219)), indicating (in BI field (218) and S field (217), respectively) that this selected RABI is in the Offered (O) state. BA field (219) field indicates the address RegA of the sending Registrar (210). Info field (220) depends on the type of message received in Step (602). If S field (217) evaluated in Step (602) is Discover (D) state, Info field (220) may hold the BI field (218) of Step (601) to indicate that it is unacceptable on the network. If S field (217) evaluated in Step (602) is Inquiry (I) state, Info field (220) holds a null CABA. Subsequently, the registrar procedure terminates at Step (609).

In Step (607), Registrar (210) determines whether BI field (218) of Step (601) exists as a RABI in the Offered (O) state in RABI database (211). If yes, then Step (608) ensues. If no, the registrar procedure then terminates at Step (609).

In Step (608), Registrar (210) transitions RABI (BI field (218) of Step (601)) to the Registered (RR) state in RABI database (211), stores BA field (219) and Info field (220) of the Request message as the Claimant Address and token, respectively, of the RABI registration, and sends a BARC message (216), to the source address of the message received in Step (601), indicating (in BI field (218) and S field (217), respectively) that this ABD is in the Registered (R) state, which ends the registrar procedure (per Step 609).

In one embodiment, Advisor (213) takes the following steps in the Advisor procedure, as illustrated in FIG. 7. In Step (701), Advisor (213) receives a BARC message indicating a PABD in BI field (218) and indicating the Inquiry (I) state in S field (217). That message may have originated at First Claimant (202) in Step (503), so BA field (219) indicates the address of First Claimant (202) originating the Inquiry and Info field (220) indicates the IID of the Inquiry.

In Step (702), Advisor (213) selects a PABD PABD2 and a Registrar Address (RegA) to propose in response to the BARC message of Step (701). PABD2 is a PRABI for the claimant to consider for the content of a future Inquiry message or a proposed CABA that a claimant can consider as the basis of a future Discover message. In selecting PABD2 and RegA, Advisor (213) may consider various aspects of the BARC message received, including the local identifier of the port on which Advisor (213) received it and the Virtual LAN (VLAN) of that BARC message. RegA is an address of a proposed Registrar that a claimant can consider as the destination address of a future Inquiry message. RegA may be set to a null CABA or RABI in order to indicate no recommendation regarding the CABA or RABI value. Step (702) may be deferred rather than be executed immediately following Step (701); in such cases, information regarding the BARC message received in Step (701), including the VLAN and the local identifier of the port on which the Advisor received it, may be stored until Advisor (213) is ready to execute Step (702).

In Step (703), Advisor (213) sends, to the source of the BARC message of Step (701) (BA field (219) of the message received in Step (701)), a BARC Proposal message indicating the selected PABD2 as BI field (218) and the selected RegA as BA field (219). Info field (220) indicates the IID of the Inquiry, duplicated from the Info field (220) of the Inquiry, which ends the advisor procedure (per Step 704).

In one embodiment, First Claimant (202) takes the following steps in the offer reception procedure, as illustrated in FIG. 8. In Step (801), First Claimant (202) receives an Offer BARC message (216) indicating in BI field (218) a RABI in the Offered (O) state. That message may have originated at Registrar (210) in Step (606). In Step (802), First Claimant (202) stores the RABI of Step (801) in its First Claimant ABD database (203), indicating that the RABI is in the Offered state, also storing, in association with that RABI, the value of BA field (219) as the sending Registrar Address of BI field (218).

In Step (803), if Info field (220) of the Offer message is a CABA set to the D state in the First Claimant ABD database (203), First Claimant (202) sets it to the Vacant (V) state, or some other state indicating that it is no longer in Discover (D) state, which ends the offer reception procedure (per Step 804).

In one embodiment, First Claimant (202) takes the following steps in the proposal reception procedure, as illustrated in FIG. 9. In Step (901), First Claimant (202) receives a Proposal BARC message (216) indicating, in BI field (218), a PABD in the Proposed (P) state, indicating a Registrar Address RegA in BA field (219) and indicating the IID of the Inquiry in the Info field (220). This BARC message (216) may have originated at Advisor (213) in Step (703).

Next, in Step (902), First Claimant (202) stores the PABD of Proposal BARC message (216) of Step (901) in its First Claimant ABD database (203), indicating that the PABD is in the Proposed (P) state, also storing, in association with that PABD, the RegA and IID of the Proposal message per Step (901). First Claimant (202) may also store the identifier of the port and the VLAN on which the Proposal message was received. This ends the proposal reception procedure.

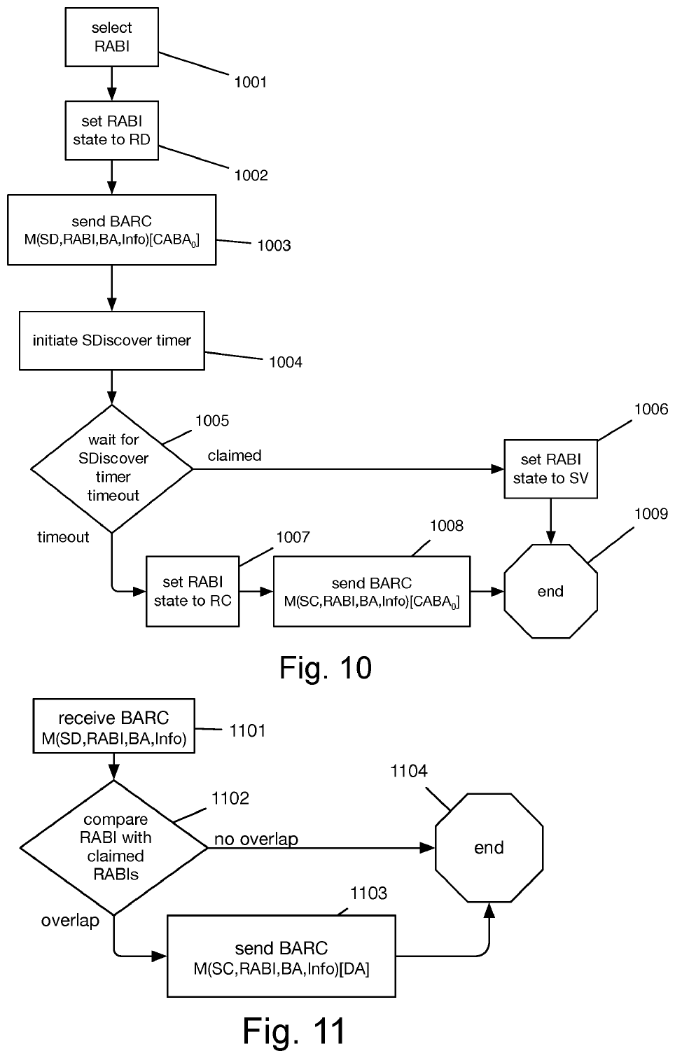

In one embodiment, Registrar (210) takes the following steps in the RABI claim procedure, as illustrated in FIG. 10. In Step (1001), Registrar (210) selects a RABI to claim. Registrar (210) checks to ensure that the RABI does not share RAs with any of its existing RABIs in the SClaimed (SC) state within its RABI database (211), checking by use of Equation (14) or other methods that produce the same result. Next, in Step (1002), Registrar (210) sets the RABI selected in Step (1001) to the SDiscover (SD) state in RABI database (211).

In Step (1003), Registrar (210) sends a BARC message (216) to the null CABA indicating (in S field (217) and BI field (218)) that the RABI selected in Step (1001) in the SDiscover (SD) state. In some embodiments, BA field (219) field contains a unicast address of the Registrar (210).

In Step (1004), Registrar (210) initiates and sets the RDiscover timer to a specified value and initiates its countdown toward expiration. Next, in Step (1005), Registrar (210) waits for the RDiscover timer to expire. If, while waiting, Registrar (210) receives a BARC message indicating that the selected RABI is in the SClaimed (SC) state, then the “claimed” branch is followed and Step (1006) ensues. Otherwise, when the RDiscover timer expires, the “timeout” branch is followed and Step (1007) ensues.

In Step (1006), Registrar (210) sets the RABI selected in Step (1001) to the SVacant (SV) state in RABI database (211), and the RABI claiming procedure ends.

In Step (1007), Registrar (210) sets the RABI selected in Step (1001) to the SClaimed (SC) state in RABI database (211).

In Step (1008), Registrar (210) sends a BARC message (216) to the null CABA indicating (in BI field (218) and S field (217), respectively) that the RABI selected in Step (1001) is in the SClaimed (SC) state, which ends the RABI claiming procedure (per Step 1009).

In one embodiment, Registrar (210) takes the following steps in the RABI defend procedure, as illustrated in FIG. 11. In Step (1101) Registrar (210) receives a BARC message (216) indicating (in S field (217) and BI field (218)) that a RABI is in the SDiscover (SD) state. This message may have been sent by a remote registrar, per Step (1003). In some embodiments, BA field (219) field contains a unicast address of that remote registrar. Next, in Step (1102), Registrar (210) compares the RABI, per BI field (218) received in Step (1101), to RABIs in the SClaimed (SC) state within its RABI database (211). The comparison checks for overlap; i.e., whether the compared RABIs share RAs, checking by use of Equation (14) or other methods that produce the same result. If an overlap is detected with any RABI in SClaimed (SC) state in RABI database (211) of receiving Registrar (210), then Step (1103) ensues. Otherwise, the RABI defend procedure terminates.

In Step (1103), Registrar (210) sends a BARC message (216) indicating (in S field (217) and BI field (218)) that the RABI received in Step (1101) is in the SClaimed (SC) state. In some embodiments, that message is addressed to a DA set to the unicast address of the remote registrar, as determined in Step (1101). In some other embodiments, that message is addressed to a DA set to the null CABA for receipt by other registrars, which ends the RABI defend procedure (per Step 1104).

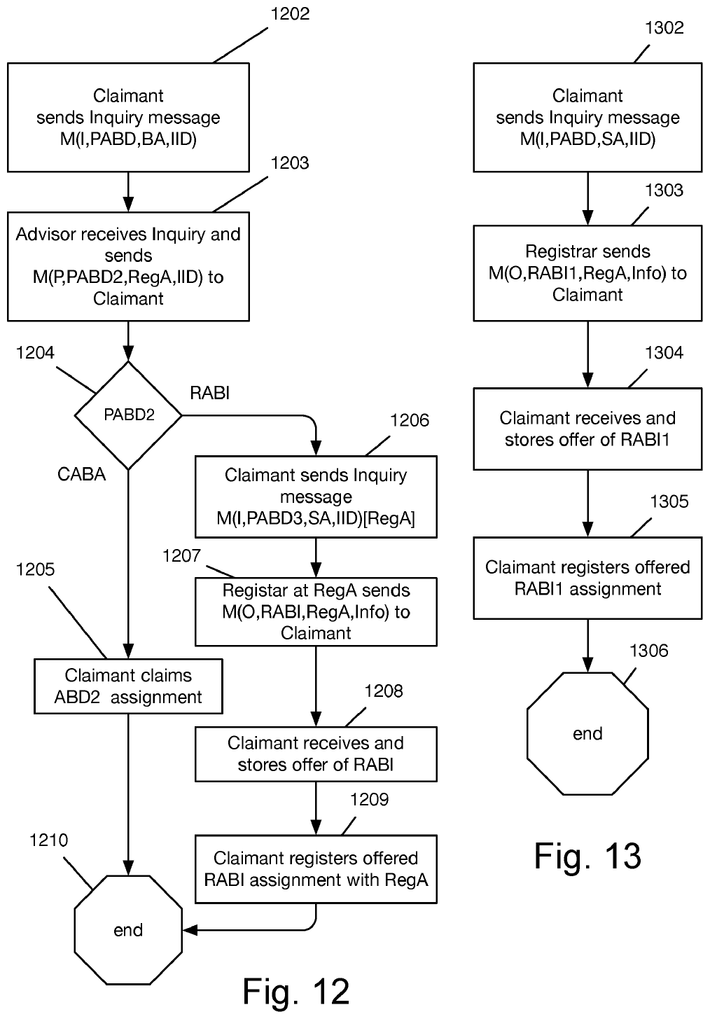

In one embodiment, a Claimant/Advisor procedure includes steps illustrated in FIG. 12. In Step (1202), First Claimant (202), following the Inquiry procedure of FIG. 5, sends an Inquiry BARC message (216), as in Step (503), specifying a PABD, which may be a CABA or PRABI. Next, in Step (1203), Advisor (213) receives the Inquiry BARC message (216) of Step (1202). Advisor (213), following the advisor procedure of FIG. 7, sends a Proposal message, as in Step (703), to First Claimant (202) (at an address found in BA field (219) of the Inquiry message of Step (1202) in which the proposed ABD is a value PABD2 that is compatible with ABD1. PABD2 may be a CABA or PRABI.

In Step (1204), First Claimant (202) extracts PABD2 and RegA as the BI field (218) and BA field (219) parameters, respectively, of BARC message (216) received per Step (1203), and determines whether PABD2 is a CABA or a RABI. If it is a CABA, then Step (1205) ensues. If it is a RABI, then Step (1206) ensues.

In Step (1205), First Claimant (202) claims an AB assignment using the AB claiming procedure of FIG. 3, determining in Step (302) that no RABI is suitable and selecting as a CABA, in Step (306), the PABD2 received per Step (1203) and the procedure ends (per Step 1210).

In Step (1206), First Claimant (202), following the Inquiry procedure of FIG. 5, sends an Inquiry message, as in Step (503), to RegA as identified in Step (1204), specifying PABD3, which is consistent with PABD2 of Step (1204).

In Step (1207), the Registrar at RegA selects a RABI to offer and sends an Offer BARC message (216), as in Step (605) and Step (606) of FIG. 6. Offer BARC message (216) includes the selected RABI as the BA field (219) and RegA as the BI field (218).

In Step (1208), First Claimant (202) receives the Offer BARC message (216) and stores the RABI, per the offer reception procedure illustrated in FIG. 8.

In Step (1209), First Claimant (202) follows the AB claiming procedure of FIG. 3, determining in Step (301) that the RABI in Offered state per Step (1208) is suitable, requesting it per Step (303), and completing registration, which ends the Claimant/Advisor procedure in Step 1210.

(0188) In one embodiment, a Claimant/Registrar procedure comprises steps illustrated in FIG. 13. In Step (1302), First Claimant (202), following the Inquiry procedure of FIG. 5, sends an Inquiry BARC message (216), as in Step (503), specifying a PABD, which may be a CABA or PRABI. Because Step (1302) is identical to Step (1202), First Claimant (202) may initiate the Claimant/Advisor and Claimant/Registrar procedures with the same action, without advance knowledge of whether Inquiry BARC message (216) will be received by Advisors, Registrars, or both.

In Step (1303), Registrar (210) receives the Inquiry BARC message (216) of Step (1302). Registrar (210), following the registrar procedure of FIG. 6, selects, per Step (605), a RABI RABI1that is compatible with PABD of Step (1302) and sends an Offer message, per Step (606), to First Claimant (202). In Step (1304), First Claimant (202) extracts and saves RABI1 and RegA as the BI field (218) and BA field (219) parameters, respectively, of the Offer BARC message (216) received per Step (1303).

In Step (1305), First Claimant (202) follows the AB claiming procedure of FIG. 3, determining in Step (301) that the RABI in Offered state per Step (1208) is suitable, requesting it per Step (303), and completing registration., which ends the Claimant/Registrar procedure (per Step 1306).

### Concluding Comments

This description is presented to enable any person skilled in the art to make and use the embodiments. All matter contained in the above description and shown in the accompanying drawings is to be interpreted as illustrative examples and not in a limiting sense. Various modifications to the disclosed embodiments will be readily apparent to those skilled in the art, and the general principles described herein are applicable to other embodiments and applications without departing from the spirit and scope of the present disclosure.

The quantity of entities shown in the drawings and tables are for exemplification purposes only and does not indicate any restriction regarding the actual number of such entities. The division of entities is for clarity and does demand separation of such entities. For example, a device configured to serve as BARC message (216) could also be configured to simultaneously serve as Registrar (210) and/or as Advisor (213).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. In a computer network, a claimant configured to send a first discover message to a first identifying address, the first identifying address identifying a first plurality of addresses for potential use by the claimant as network source or destination addresses.

2. The claimant of claim 1 wherein the first identifying address is a multicast address.

3. The claimant of claim 2, wherein the claimant is further configured to enable sending a data message whose source or destination address is within the first plurality of addresses identified in the first discover message.

4. The claimant of claim 2 wherein the claimant is further configured to:
in response to receiving a claimed message indicating that the first plurality of addresses, identified by the first identifying address, is unavailable, send a second discover message to a second identifying address, the second identifying address being a multicast address identifying a second plurality of addresses for potential use by the claimant as network source or destination addresses.

5. In a computer network, a claimant configured to receive a message containing an address block identifier as an indication of a plurality of addresses identified by the address block identifier, wherein the address block identifier's length is no larger than the length of any address within the plurality of addresses, and to enable sending of a data message whose source or destination address is within the plurality of addresses.

6. The claimant of claim 5 wherein the plurality of addresses includes both unicast and multicast addresses.

7. A method of claiming network addresses for use in a computer network, comprising:
sending, by a claimant, a first discover message to a first identifying address, the first identifying address identifying a first plurality of addresses for potential use by the claimant as network source or destination addresses in a computer network.

8. The method of claim 7 wherein the first identifying address is a multicast address.

9. The method of claim 8, further comprising:
enabling the claimant to send a data message whose source or destination address is within the first plurality of addresses identified in the first discover message.

10. The method of claim 8, further comprising:
in response to receiving a claimed message indicating that the first plurality of addresses, identified by the first identifying address, is unavailable, sending a second discover message to a second identifying address, the second identifying address being a multicast address identifying a second plurality of claimed addresses for potential use by the claimant as network source or destination addresses.

11. In a computer network, a method of attaining and using network addresses by a claimant, comprising:
receiving, by the claimant, a message containing an address block identifier as an indication of a plurality of addresses identified by the address block identifier, wherein the address block identifier's length is no larger than the length of any address within the plurality of addresses; and
enabling the claimant to send a data message whose source or destination address is within the plurality of addresses.

12. The method of claim 11 wherein the plurality of addresses includes both unicast and multicast addresses.

13. A computer program product comprising a non-transitory computer-readable storage medium storing instructions that when executed by a computer configure the computer to perform a method of claiming network addresses for use in a computer network, comprising:
sending, by a claimant in a computer network, a first discover message to a first identifying address, the first identifying address identifying a first plurality of addresses for potential use by the claimant as network source or destination addresses in a computer network.

14. The computer program product of claim 13 wherein the first identifying address is a multicast address.

15. The computer program product of claim 14 wherein the instructions configure the claimant to enable the claimant to send a data message whose source or destination address is within the first plurality of addresses identified in the first discover message.

16. The computer program product of claim 14 wherein the instructions configure the claimant to:
in response to receiving a claimed message indicating that the first plurality of addresses, identified by the first identifying address, is unavailable, send a second discover message to a second identifying address, the second identifying address being a multicast address identifying a second plurality of claimed addresses for potential use by the claimant as network source or destination addresses.

17. A computer program product comprising a non-transitory computer-readable storage medium storing instructions that when executed by a computer configure the computer to perform a method of attaining network addresses for use in a computer network, comprising:
receiving a message containing an address block identifier as an indication of a plurality of addresses identified by the address block identifier, wherein the address block identifier's length is no larger than the length of any address within the plurality of addresses; and
enabling sending of a data message whose source or destination address is within the plurality of addresses.

18. The computer program product of claim 17 wherein the plurality of addresses includes both unicast and multicast addresses.
